(19) United States
(12) Patent Application Publication
(10) Pub. No.: US 2011/0178885 A1
(43) Pub. Date: Jul. 21, 2011

(54) System and Method for Universally Managing and Implementing Rating Systems and Methods of Use

(75) Inventor: Viler Xiong, Golden, CO (US)

(73) Assignee: Wisper, Inc., Westminster, CO (US)

(21) Appl. No.: 13/007,542

(22) Filed: Jan. 14, 2011

Related U.S. Application Data
(60) Provisional application No. 61/295,875, filed on Jan. 18, 2010.
(60) Provisional application No. 61/307,738, filed on Feb. 24, 2010.

(51) Int. Cl. G06Q 10/00

(52) U.S. Cl. 705/16; 705/347

(57) ABSTRACT

A system and method for universally managing and implementing rating systems and methods of use are provided that provides attributes that are not present in the typical commerce rating and customer relationship management systems. The rating system provides a business product (or family of products), which are designed to be centrally managed, universal, and comprehensive for the purpose of reviewing and rating commerce for individuals and businesses.

### PRIORITY CLAIMS/RELATED APPLICATIONS

This patent application claims the benefit under 35 USC 119(e) to U.S. Provisional Patent Application Ser. No. 61/295,875, filed on Jan. 18, 2010 and titled “System for Universally Managing and Implementing Commerce Rating Systems and Methods of Use” and to U.S. Provisional Patent Application Ser. No. 61/307,738, filed on Feb. 24, 2010 and titled “System for Universally Managing and Implementing Reviews and Ratings Via Phone Number Associations and Tracking”, the entirety of both of which are incorporated herein by reference.

### FIELD

The disclosure relates generally to a business engaged in product and service offerings for which customer feedback, user activity and customer demographic information is of value.

### BACKGROUND

As our economy shifts towards ever increasing reliance on Web-based information transfer for business transactions, the business reputations of merchants and individuals becomes ever more difficult to establish and maintain. Similarly, with increased reliance on Web-based commerce comes new opportunities for business fraud, abuse, and inadvertent damage to business reputations. In order to establish and maintain a good reputation, numerous Web-based retailers now post on-line reviews of their products and services solicited by previous customers. Furthermore, some sites are now posting reviews on customers to establish their reliability in conducting on-line purchases and sales.

At the same time, traditional “brick and mortar” businesses are struggling to compete with on-line retailers, and seeking new means to establish and maintain a positive reputation with customers, as well as to develop more intimate relationships with customers leading to increased customer loyalty and capitalizing on their inherent advantage as “high-touch” service providers as compared to their Internet-based counterparts. Against this backdrop of evolution in the retail and service business sectors, there is an emerging need for improved customer feedback and relationship management (CRM) systems that serve both Internet-based, as well as traditional “brick and mortar” businesses.

From the perspective of merchants and businesses engaged in product and service offerings, the system and method addresses the following limitations of current customer-feedback and CRM systems and protocols: 1) difficulty in securing commitment from customers to provide feedback (i.e., low percentage of customers registering feedback), 2) difficulty in securing valuable customer demographic data, 3) difficulty in relating feedback information to specific employees (i.e., gathering of employee performance information), 4) lack of efficient means to reconcile bad reviews and ultimately satisfy a customer's concerns—turning a bad experience into a good experience, 5) lack of efficient means to communicate results of past reviews to current and future customer, 6) lack of efficient means to manage, distribute, and track awards (of monetary value) that might be transferred to customers in order to incentivize participation in a customer-feedback process and/or to reconcile a bad experience with the business, 7) inability to track user activity and trending; and 8) lack of efficient means to distill customer review and demographic information into value-added market research data.

From the perspective of customers who might patronize a business and chose to participate in the process of providing feedback, the system and method addresses the following limitations of current customer-feedback and CRM systems and protocols: 1) impractical amount of time required on behalf of customer in order to participate, 2) requirement to provide feedback through a single information source (often through the Web, which is not readily available to the customer at the point of sale), 3) lack of a universal format/protocol for providing feedback (i.e., each business currently uses a unique system/protocol that the customer must learn and adapt to), 4) lack of clear motivation to provide feedback (i.e., no clear tie to incentives for providing feedback), and 5) lack of visibility into the feedback system, and “ownership” over one's reviews once posted (i.e., ability to adjust/amend feedback in future and/or ability to communicate feedback to friends in one's own personal network who might appreciate hearing the information).

Previous systems for commerce rating and customer management have generally fallen into three categories: 1) systems for gathering customer feedback, 2) systems for managing good relationships with customers, and 3) systems for extracting and interpreting meaningful market research information from customers. No previous system has been developed that adequately performs all of these different functions. Hence, it is desirable to provide a system and method that accomplishes all three of these tasks within a single, centrally managed and universal system, and in a manner that better balances the viewpoints and interests of both merchant and customer.

Furthermore, previous systems for associating people with their cell phone numbers have generally fallen into two categories: 1) systems for coupling a person's cell phone number with Web-based personal identification information, and 2) systems for using a cell phone and its associated number and user registration information as a means to validate a business transaction with the owner of the phone. None of these prior systems are specifically designed for the purpose of associating entities (both individuals and businesses) with their cell phone number for the purpose of registering, maintaining, and communicating review information associated with commerce or other users. It is desirable to provide a system and method that provides a novel adoption of the association between entity and cell phone number.

Thus, it is desirable to provide a system and method that provides ratings and associates a person with their phone number and it is to this end that the disclosure is directed.

### BRIEF DESCRIPTION OF THE DRAWINGS

FIG. 1 illustrates an implementation of a system for universally managing and implementing commerce rating systems;

FIG. 2 illustrates more details of the application module of the system shown in FIG. 1;

FIG. 3 illustrates an implementation of the application module of the system shown in FIG. 1;

FIG. 4 illustrates an example of a database schema for the storage unit of FIG. 1;

FIG. 5 illustrates an aspect of the system 100 for universally managing and implementing commerce rating systems to uniquely identify entities;

FIG. 6 illustrates an example of the user interaction within the system for universally managing and implementing commerce rating systems;

FIG. 7 illustrates a rating method implemented by the system for universally managing and implementing commerce rating systems;

FIG. 8 illustrates a method for instantaneous reviews at a point of sale using the system for universally managing and implementing commerce rating systems;

FIG. 9 illustrates a method for merchant/user collaborations using the system for universally managing and implementing commerce rating systems;

FIG. 10 illustrates a sign up process of the system for universally managing and implementing commerce rating systems;

FIG. 11 illustrates a sign up process to register a business of the system for universally managing and implementing commerce rating systems;

FIG. 12 illustrates a login process of the system for universally managing and implementing commerce rating systems;

FIGS. 13 and 14A illustrate an invite friends flow of the system for universally managing and implementing commerce rating systems;

FIG. 15 illustrates a business flow of the system for universally managing and implementing commerce rating systems;

FIG. 16 illustrates an example of a user interface of the universally managing and implementing commerce rating systems that has a portable rating card;

FIG. 17 illustrates a public page of the system for universally managing and implementing commerce rating systems; and

FIG. 18 illustrates an example of the reports that can be generated using the system for universally managing and implementing commerce rating systems.

### DETAILED DESCRIPTION OF ONE OR MORE EMBODIMENTS

The disclosure is particularly applicable to a Web based system and method for universally managing and implementing ratings system and it is in this context that the disclosure will be described. It will be appreciated, however, that the system and method has greater utility because the system and method can be implemented using other architectures, other computer architectures and the like.

The system and method for universally managing and implementing rating systems and methods of use (the “universal rating system and method”) uses recently developed communication protocols (e.g., SMS text messaging, Web 2.0 social networking, etc.), and provides attributes that are not present in the prior art of commerce rating and customer relationship management systems. The commerce rating system provides a business product (or family of products), which are designed to be centrally managed, universal, and comprehensive for the purpose of reviewing and rating commerce for individuals and businesses. The system is “universal” in the sense that the system and method can be used on or by any Website, simply via an html Website reference, or be it integrated through an application programming interface (API), and it can also be utilized by other communication systems such as a cell phone, through interactive TV or using a kiosk. Through this “universal” format, the system addresses each of the limitations identified above in current customer-feedback and CRM systems which will lead to pervasive adoption and use. In an initial implementation, the system is envisioned to gain wide acceptance within the business sector as a means to significantly increase the percentage of customers willing to provide feedback and provide the framework to remain connected with the customer base in order to better track customer feedback and market information. In later implementations, the system is envisioned to lead to widespread adoption among customers (i.e., users) as an efficient and universal means to communicate with one another (via existing social networking protocols) on customer feedback issues.

A method for linking an entity (either a customer or a merchant) to a phone number or a phone number to an entity for the purpose of tracking interactions between entities, be it social, professional, or monetary is also provided. The method exploits the ubiquitous nature of phone numbers and the intrinsic connection between phone numbers and text messages—a primary mechanism for transferring information in the system. The method works by simply assigning a second unique identifier, including but not limited to, a personal identification number (PIN), to each entity and a phone number. Should the entity want to change their phone number, all they need to do is log into the central management database, verify they are the existing owner of the old phone number and provide the correct PIN. Normal verification process would include calling the entity and verifying their PIN over the old phone.

The system has a mechanism/process to compete commercially with all current customer-feedback protocols. In particular, the competitive Web-based protocols used by on-line merchants tend to be biased in favor of either the merchant (e.g., current merchant-controlled protocols), which leads to lack of publication of critical information, or the systems are biased in favor of the customer (e.g., Yelp), which leads to lack of an ability for merchants who receive bad reviews being able to address, and possibly reconcile, the bad experience. The competitive protocols used by “brick and mortar” merchants all suffer from poor use rates by customers due to their cumbersome nature. The system provides features that address these limitations in current systems, and through these features provides the way for Wisper, Inc. (the assignee of the present patent application and the company that runs a commercial version of the system and method described herein) to compete for market share in this business sector. In the future commercial implementation, Wisper, Inc. intends to implement commercially available software and support services that will market the system and method to a broad range of business clients (ranging from small local businesses to large national chains and franchises). The products and services are envisioned to attract millions of dollars in annual revenue through monthly subscription fees, and over time the system is well-positioned to emerge as a new industry standard for customer feedback and relationship management.

The system entices first-time users (both customers and merchants/businesses as explained below) to register and become repeat users of the system. In more detail, a customer has instant gratification as the customer is able to see posted reviews immediately and/or interact further with the merchant/business to correct the issues with a service problem in a timely fashion as described below in more detail. For the merchants/business, the system allows the merchant/business, if negatively reviewed/rated, to sign up and be able to resolve the bad review/rating before the review/rating becomes public as described below in more detail.

The system also may provide the ability to generate and transfer between users (such as merchants and customers) an electronic form of currency that is recognized within the system and is convertible to monetary or equivalent value by users of the system (such as merchants.) For example, the currency may be used to encourage users to be part of the system and encourage users to take certain actions in the system, such as posting reviews/rating, accepting a conversation with a merchant/business who you gave a bad rating/review to, etc. The system also encourages contact with the customer and merchant that builds customer loyalty for the merchant.

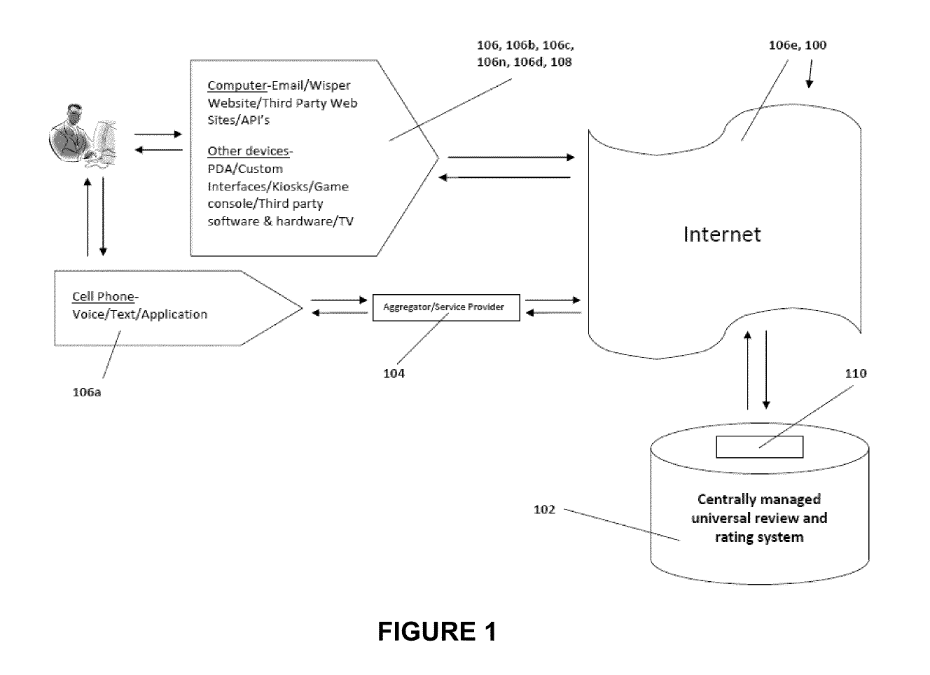

FIG. 1 illustrates an implementation of a system 100 for universally managing and implementing commerce rating systems. In this implementation, the system is implemented using a plurality of lines of computer code executed by one or more processing units of one or more computing devices. However, the system may also be implemented in hardware or a combination of hardware and software that are within the scope of the system. In the embodiment in FIG. 1, the software routines that comprise portions of the system (an application module 102) may reside primarily on the Internet and with interface communication pathways (one or more two way communication modules 104 as shown in FIG. 1) to a variety of input-output devices 106 that have one or more processing units, memory, storage, communications capabilities and input/output capabilities to interact with the system 100 over a link. This embodiment of the system and method may include a dedicated storage unit 110, such as a database or other storage mechanism, for storage of information gathered through the system and of interest to the system users (e.g., reviews, user and merchant account information, system usage data, etc.).

Each input-output device may be a telephone, a smartphone (Apple iPhone, Palm device, RIM device, etc.), a kiosk, a cell phone 106a, a PDA 106b, an interactive TV 106c, gaming consoles 106d and any other device that can access the Internet as well over the Internet 106e wherein an online user computer or Web-enabled device may interact with the system 100. Furthermore, the system 100 would interface with a variety of existing and future Web-based protocols and Websites 108 (e.g., social networking sites like Twitter, LinkedIn, Facebook, auction sites, advertisements, news, blogs, etc.) to provide enhanced modes of interaction (i.e., input-output), as well as to enable mining and inclusion of relevant information already posted and maintained through those existing Web sites (e.g., user and merchant personal information). The system uses texting/SMS, emails or digital phone calls for communication with the input/output devices so that the user of the system can use almost any mobile device without requiring a downloadable application. The system is therefore able to be used by users who do not have smartphones and the like. The system also permits a user to send an email review (with the review and a phone number) into the system to post a review. The system may also permit a review using voice recognition. Downloadable applications for smartphones could also be provided to give smartphone users access to greater functionality without being connected to the Internet.

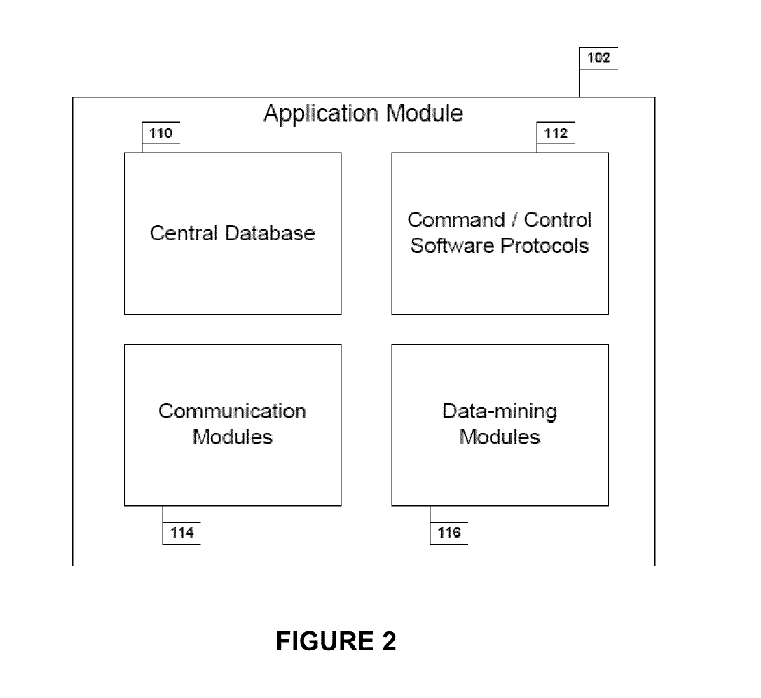

FIG. 2 illustrates more details of the application module 102 of the system shown in FIG. 1. The elements of this embodiment of the system shown in FIG. 2 may include the dedicated storage unit 110 (that may be a central database) to store all the required information and user data, though in some embodiments, this central database may be comprised of, and distributed among, multiple data repositories/machines that may be located in same location or geographically distributed. The system also may have a logic engine 112 (a collection of command/control software protocols) that will act as the brain to interpret information entered into the system (e.g., user and merchant profiles, ratings, etc.) calculate meaningful results (e.g., user ratings) and manage all the tasks that are required. The system also may have a collection of communication modules 114 that will process and communicate with other input-output devices such as cell phones, PDAs, etc., as well as existing Web-based social networking protocols and information repositories (these are shown in FIG. 1 as the two way communication devices 104). The system also may have a collection of data-mining modules 116 that will interpret data entered into the system and provide strategic marketing information to merchants and/or users for a subscription fee.

From a functional perspective, the system provides users and merchants with the following valuable operational capabilities:

1) Capability to attract “instantaneous” (i.e., on-the-spot) reviews at the point of sale, and via a very efficient electronic interface (e.g., cell phone/text messaging, voice recognition, etc.) in order to greatly increase the percentage of customers who will leave reviews with a subscribing merchant.

2) Capability for subscribing merchants to create and maintain a dialogue with a user after the point of sale for such purposes as to reconcile an unfavorable review before the review is posted in public and/or to further enhance/grow the merchant-customer relationship.

3) Capability to attract first-time users to become registered and frequent users of the system through a tiered system of information requests coupled with incentives.

4) Capability to generate and transfer an electronic “currency” that can be used by merchants to incentivize reviews and return business and that can be accumulated by users for use at other subscribing merchants.

5) A suite of Customer Relationship Management (CRM) and market-analysis capabilities to enable the subscribing merchants to develop and maintain more positive and effective relationships with customers and track/interpret useful customer/market information.

6) A customer testimonial application programming interface.

7) a portable rating.

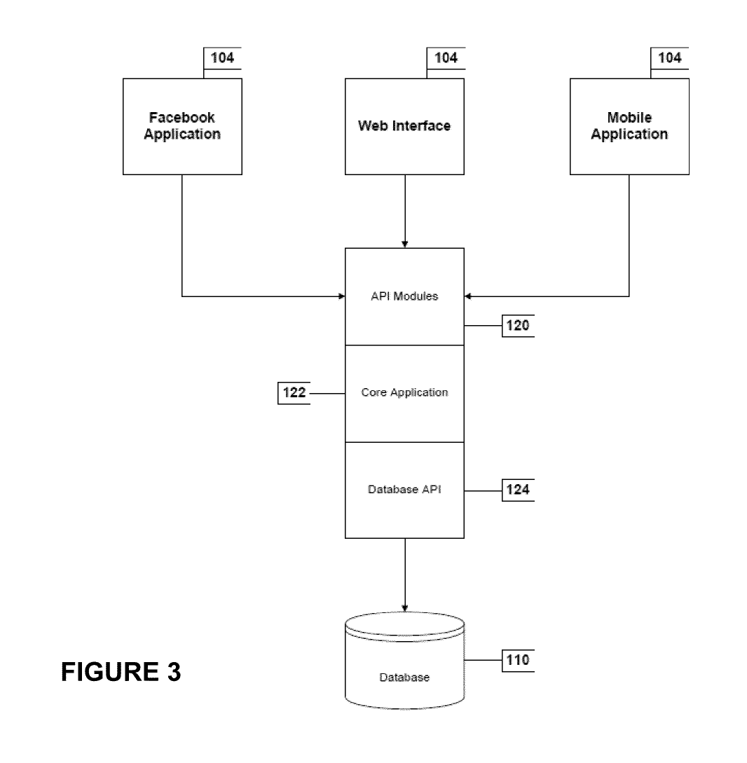

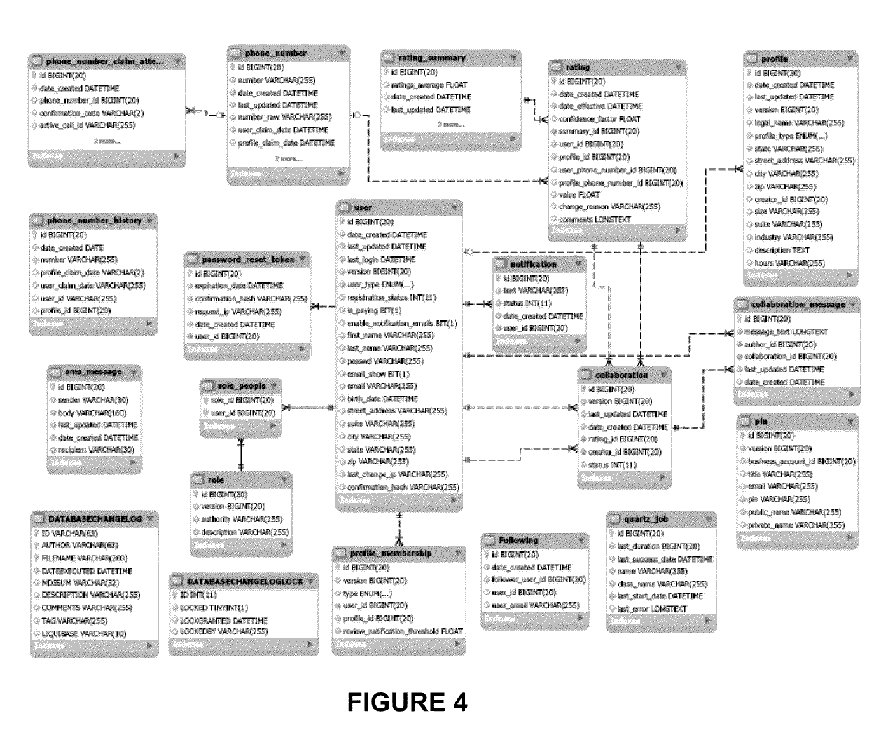

FIG. 3 illustrates an implementation of the application module 102 of the system shown in FIG. 1. The application module 102 may further comprise the storage unit 110 described above, the set of interfaces 104, such as a Facebook interface, a Web interface and/or a mobile application interface, that all feed data/information into an application programming interface (API) module 120 that performs interface functions (data conversion and data checking, protocol conversion, etc.) between the interfaces 104 of the external applications and a core application module 122 that contains, among other items, the logic engine as described above and a database application programming interface (API) module 124 that performs interface functions between the core application 122 and the storage unit 110. FIG. 4 illustrates an example of a database schema for the storage unit 110. The system may also be implemented using other database schema that would be within the scope of the disclosure. As shown in FIG. 4, the database has various relationally linked records that are used by the system 100 to implement the universal management and implementation of commerce ratings.

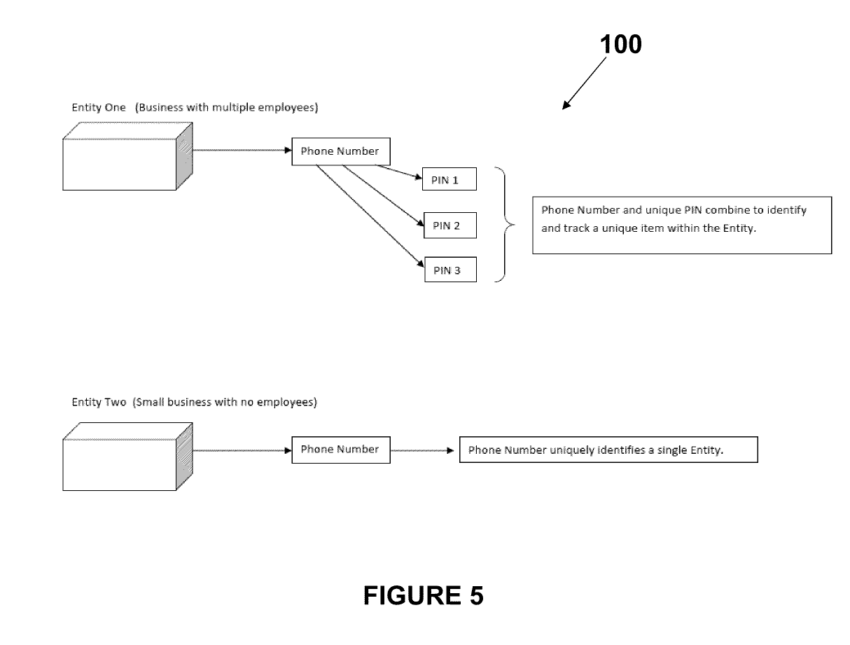

FIG. 5 illustrates an aspect of the system 100 for universally managing and implementing commerce rating systems to uniquely identify entities. In this embodiment, there are several relationship combinations available between entities (e.g., merchants and customers) and phone numbers. There can be a one to many or many to many relationships; however, the combination consisting of a phone number and a PIN must be unique in order to identify a particular entity. In the same way, any particular entity and a PIN must resolve to only one phone number. Simply put, the system allows for the association of entities to phone numbers which opens the door to a flexible system where an entity is inherently associated with a phone number—a ubiquitous and convenient numerical identifier that is easily adopted and used by other entities without the undue invasion of privacy, and a numerical identifier that is naturally associated with the SMS text messaging protocol—a preferred method of information exchange in the system. The features that constitute this embodiment of the system are:

1) An entity can be uniquely linked and identified by one or more phone numbers for the purpose of tracking their activities with other entities. For example: An entity may have one phone for work, which can be reviewed by one set of customers or clients. A second phone may also be used by the same entity, but for another purpose, and would receive appropriate reviews accordingly.

2) A phone number can be uniquely linked to one or more entities for the same purpose. For example: An on-call phone could be passed from one person to another in a rotation, and reviews are managed automatically.

3) An entity and phone number combination may have one or more methods for uniquely identifying their association. For example: An entity can also generate temporary keys/PIN that also can identify securely and uniquely who they are. This key/PIN (with limited privileges) can be given to a customer for verification and not jeopardize their own security.

4) Through this association of entity to phone number, the system enables a collection of efficient mechanisms to communicate customer review information between entities (merchant and customer, merchant and merchant, as well as customer and customer).

As shown in FIG. 5, an entity, such as a business with multiple employees, may have a phone number and one or more personal identifier numbers (PINs) that are combined to identify and track a unique employee within an entity wherein the phone number identifies the business and the PINs uniquely identify each employee. For an entity, such as small business with no employees, a phone number can be used to uniquely identify the entity.

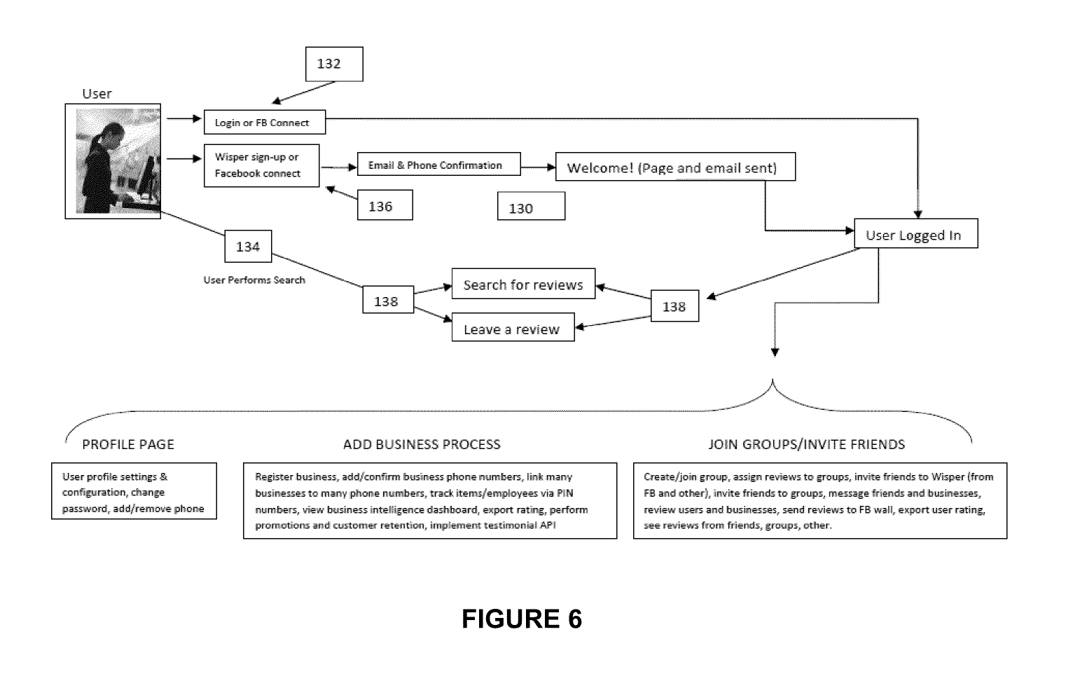

FIG. 6 illustrates an example of the user interaction 130 within the system for universally managing and implementing commerce rating systems. Initially, a user may be asked to login (132). If the user is not registered with the system and has no means to log into a personal account, the user can still perform a search process 134 that can involve performing a search for recent reviews/ratings and/or leaving a rating/review 138. The sign up for user account process 136 may include signing up for a new account, the creation of a new account by the system, a confirmation of the new account by the system and a welcome message. Once the new user account is created and the user logs in, the user has access to the resources of a logged in user that will now be described in more detail.

If the user logs into the system, the user may select for several functions/operations that may include: a settings operation to set the setting for the particular user account, an edit user profile function, a change password function, an add/remove phone number function, a business page with a register your business function, a call to confirm your business function, a search function and/or rate a business function as shown in FIG. 6.

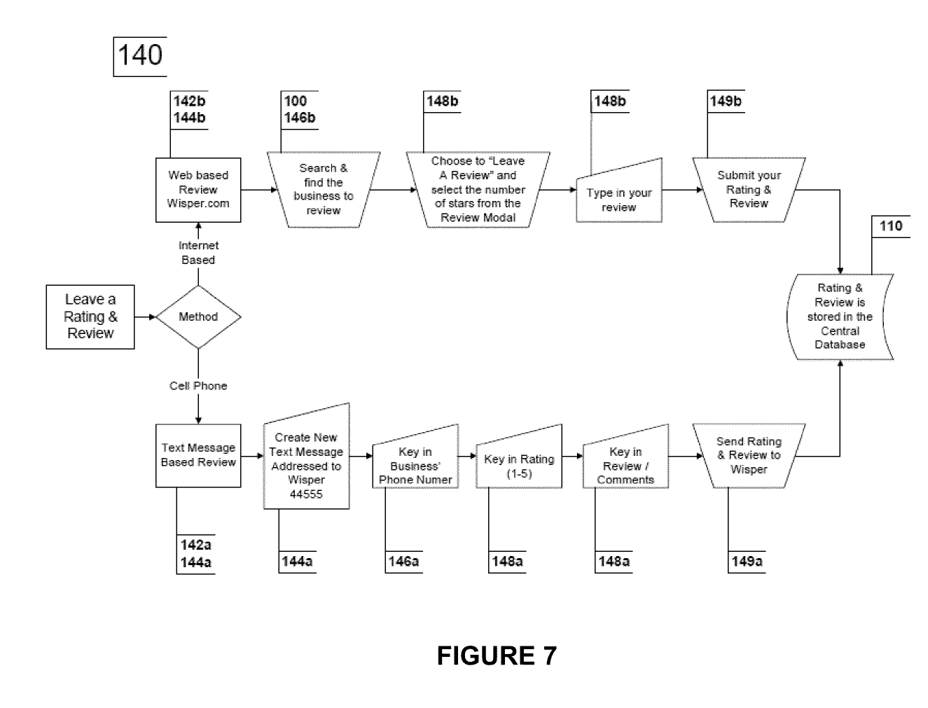

FIG. 7 illustrates a rating method 140 to leave a rating implemented by the system for universally managing and implementing commerce rating systems. The method for leaving a rating may be a method for leaving a rating using input-output devices (such as a cell phone) 142a to generate an input-output device rating 144a and/or a method for leaving a rating using the Web 142b to generate an Internet-based rating 144b of the system. For the rating using the input/output device, the method involves the user entering a merchant's number (such as a phone number) 146a and the user entering a predetermined number of stars (one to five stars in one example) and review comments 148a via a communication method, such as texting in one embodiment, and then the user sends the final review (149a) to the system 100. For the Internet-based rating, a user finds a business through the system 100 search function 146b, the user leaves star ratings and review comments 148b and the submit the final review 149b over the Internet through the system's Website. The review stars and review comments entered using various techniques are then stored in the central store 110 so that, for example, the review may be displayed in the rating system 100

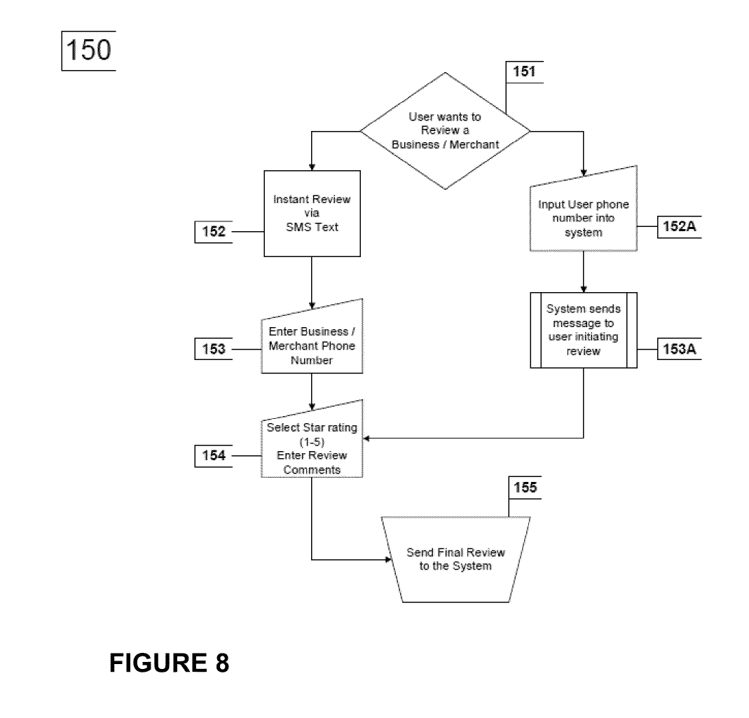

FIG. 8 illustrates a method 150 for instantaneous reviews at a point of sale using the system for universally managing and implementing commerce rating systems. In the process (that is implemented by the system 100 shown in FIG. 1), a user wants to review a product, service, and/or employee of a business/merchant (151) and the user is able to instantly send a review (152) using a communications method, such as an SMS message in one embodiment. The user may then enter a merchant number (such as a phone number in one embodiment) (153) and then enters a predetermined number of stars (one to five stars in one example) and review comments (154) and then the final review is sent over a link (155), such as over a cellular phone network or digital data network, to the system 100. At the point of sale, the system may use a dedicated rating terminal, a terminal shared between the rating system and the point of sale system or a rating kiosk.

An alternative method is for the user to provide the merchant with his/her cell phone number, and request that the merchant initiate the review dialogue through the system. In this case, the merchant initiates the review process by inputting the user's phone number (152A) using a communication method, such as an SMS message or input through an Internet connection. The system then sends a text message to the user's phone (153A) starting a text thread that the user can respond to by entering a predetermined number of stars (one to five stars in one example) and review comments (154) and then the final review is sent over a link (155), such as over a cellular phone network or digital data network, to the system 100.

Every time a user enters a review to the system, the user's phone number is associated with the review and this association is stored in the database (FIG. 4). If the user is registered in the system, the review is further associated with that user's account. If the user is not registered in the system, the review is associated with any other unregistered reviews that may have been entered previously using the same phone number. When a user registers with the system and thereby associates himself or herself with a particular phone number, the system can automatically associate the history of unregistered reviews from that particular phone number to the newly registered user. In one embodiment of the system, the user would be asked to verify that they submitted these prior reviews before the association would be made.

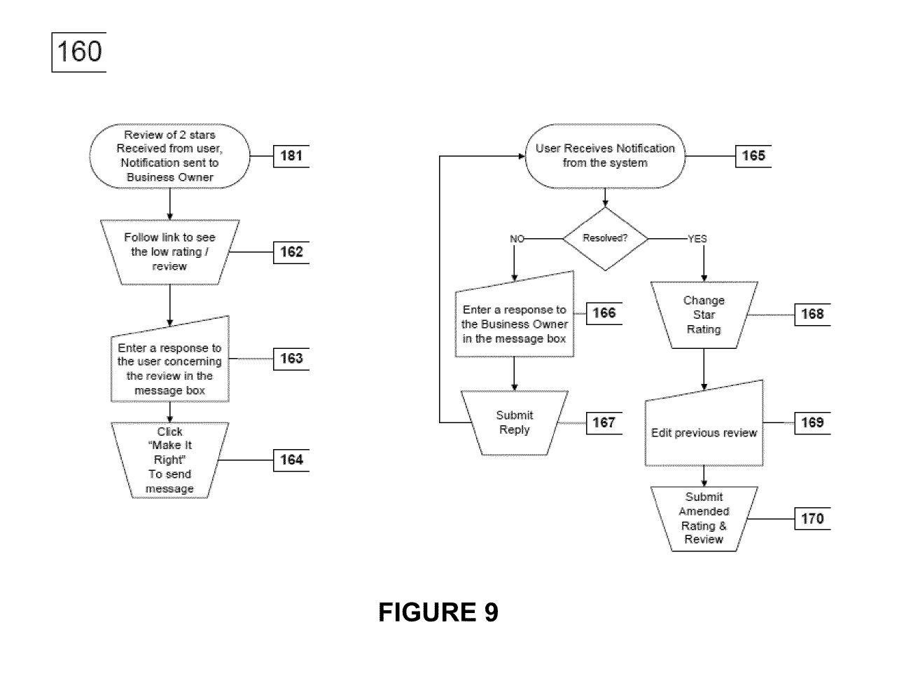

FIG. 9 illustrates a method 160 for merchant or business/user collaborations using the system for universally managing and implementing commerce rating systems. The method allows a business/merchant to establish a dialog with customers and hopefully efficiently resolve customer disputes. During the method, a business who has a review on the system 100 below some predetermined threshold value (for example, two stars out of five stars) receives a notification (181) and the merchant/business can click on a poor review option (162) and edit a message to the user who entered the poor review (163). The merchant/business may then select a “Make it Right” option (164) and then continue the conversation with the customer. The “Make it Right” option allows the merchant/business and the customer to have a conversation with each other about the bad review. In the system, the bad review does not post to the public for a predetermined period of time (such as 48 hours) to allow the merchant/business time to try to resolve the bad review. In prior systems, a customer can post an anonymous review (such as Yelp) which tends to encourage people to be less truthful as they do not have to associate their name with the review. In the system, the review is not anonymous (which tends to cause the reviews to be more truthful), but in order to maintain the privacy of the customer, the system permits contact between the merchant/business and the customer only through the system's communication mechanisms (SMS or email). The system thus controls the information flow between the parties during the conversation and provides benefits to the merchant/business (more honest reviews that they can address before they are posted) and benefits to the customers (maintaining privacy while providing a forum for reviews.) Furthermore, the system provides a mechanism for users to rate other reviewer's reviews for accuracy and useful information—a “rate-the-rater” feature, and a mechanism for weighting the reviewer's credibility accordingly which ensures accuracy and discourages abuse and false reviews.

Returning to FIG. 9 on the customer/user side, the user receives a notification from the system that there is a bad review resolution being completed (165). If the bad review resolution is not resolved, the user can enter a reply in a reply box (166) and then submit the reply (167) to the system. The system then allows the user to continue the conversation with the merchant/business until the issue is resolved. If the issue has been resolved, the user is allowed to edit the star rating of the merchant/business (168) based on the bad review resolution, edit a review text in a review text box (169) and then submit the amended review and rating (170) to the system 100.

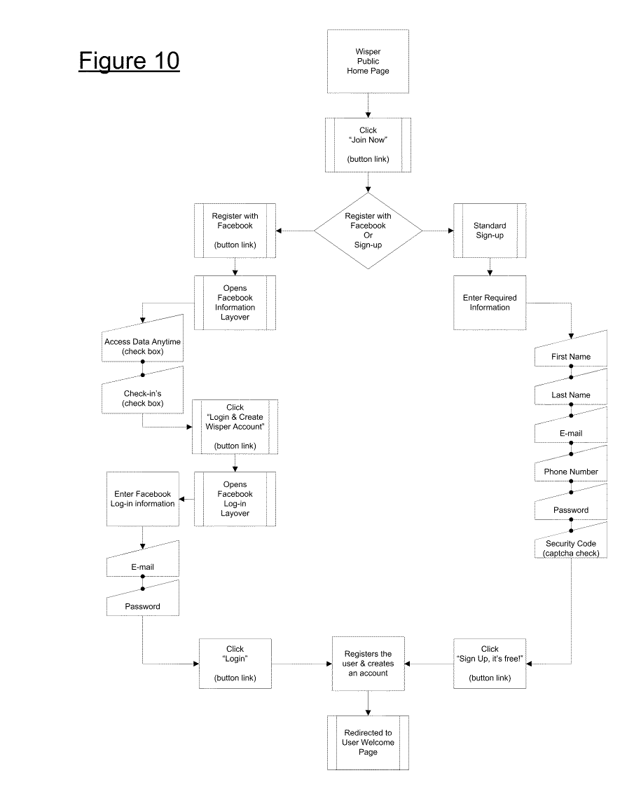

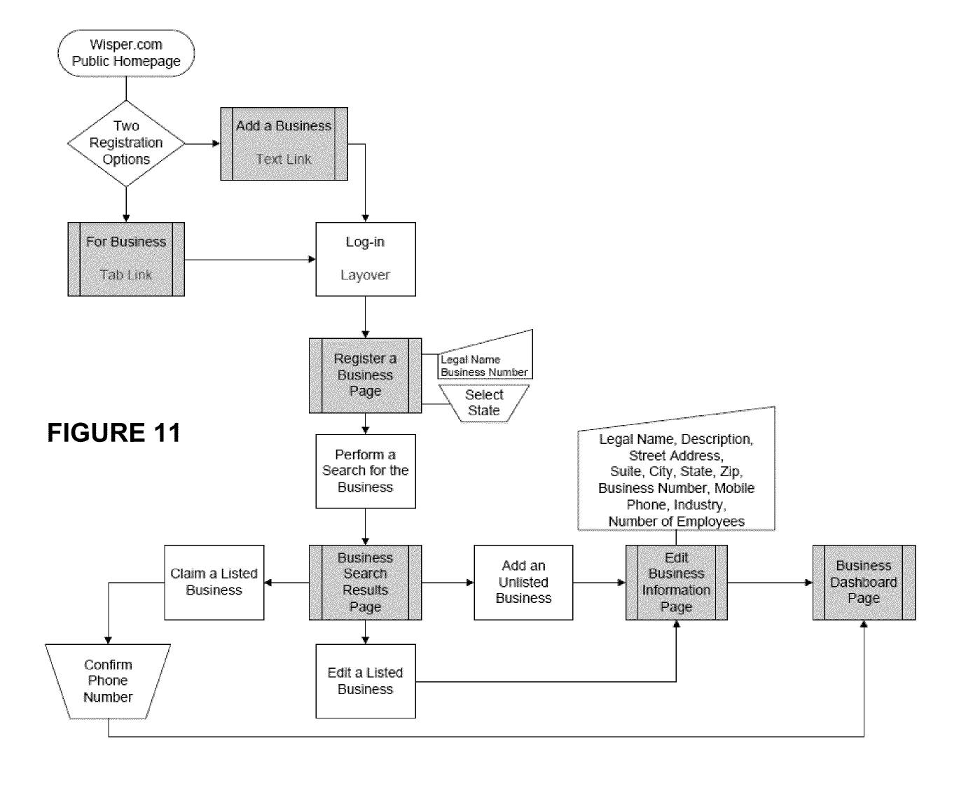

FIG. 10 illustrates a sign up process of the system for universally managing and implementing commerce rating systems and FIG. 11 illustrates the details of the sign up process to register a business of the system for universally managing and implementing commerce rating systems. The processes illustrated in FIGS. 10 and 11 allow a new user/merchant or business to sign up to the system 100.

In the sign-up process shown in FIG. 10, a new user clicks on a “Join Now” button/link on the rating system home page (when the system is implemented in part using web pages) and can either register with Facebook or do a standard sign-up. If the new user wants to register with Facebook (or any other social networking system), the user clicks on a link/button and the system opens an information layover for the particular social networking system, such as Facebook. The information layover asks whether the user wants access to data anytime and allow the user to check-in. The system may then present a login and create Wisper account link and opens a Facebook log-in layover so that the user can enter the Facebook log-in information, such as an email and password. The user may then click a log-in link or button so that the user can register and the account is created. The user is then redirected to the user welcome page of the ratings system. If the user does a standard sign-up, the user enters the standard information as shown. The user may then click a log-in link or button so that the user can register and the account is created. The user is then redirected to the user welcome page of the ratings system.

As shown in FIG. 11, the system provides two registration options that include a “For Business” registration and “add a business.” The system then generates a log-in layover which presents the business with a “register a business” page (that allows the user to register the business in a particular one or more states), a business search results page, an edit business information page and a business dashboard page. When the user performs a business search, the user can then edit a listed business information using the edit business information page, claim a listed business and confirm its phone number which are then shown on the business dashboard page, add an unlisted and edit its information.

FIG. 11 also illustrates data mining process for merchants of the system for universally managing and implementing commerce rating systems using the dashboard. Using the dashboard, merchants are able to perform important data mining for strategic marketing purposes using the dashboard page. As shown in FIG. 11, from the businesses page, the merchant can select pin management, conversations, networking, profile or the public page as described above. From the dashboard, the merchant has access to a report listing businesses or multiple businesses, a merchant profile completion bar showing the percentage of the merchant profile completed by the particular merchant, a customer notifications bar that indicates the number of customer notifications (bad review/make it right) that the particular merchant has. The dashboard may also provide a total reviews displayed link, a total bad reviews displayed link, a manage phone numbers pins menu, a rating distribution chart (interactive bar graph) for the particular merchant, a profile visits interactive line graph and a “where are your reviews coming from” interactive pie chart showing the distribution of the reviews for the particular merchant. Finally, features like key word searches of the review database will enable the merchant to quickly identify subsets of reviews that are of a similar nature or related to the same aspect of the business. All of the above dashboard features allow a merchant to quickly data mine and find relevant information to help the merchant's business generate more wealth, etc. FIG. 11 also illustrates a for you page and process of the system for universally managing and implementing commerce rating systems that show the details of a for you page that is part of the system 100.

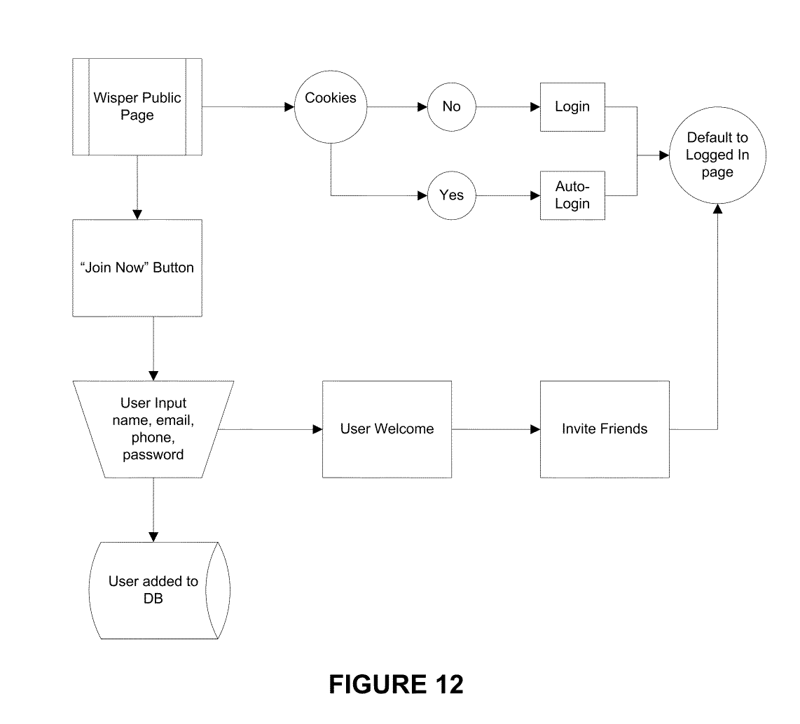

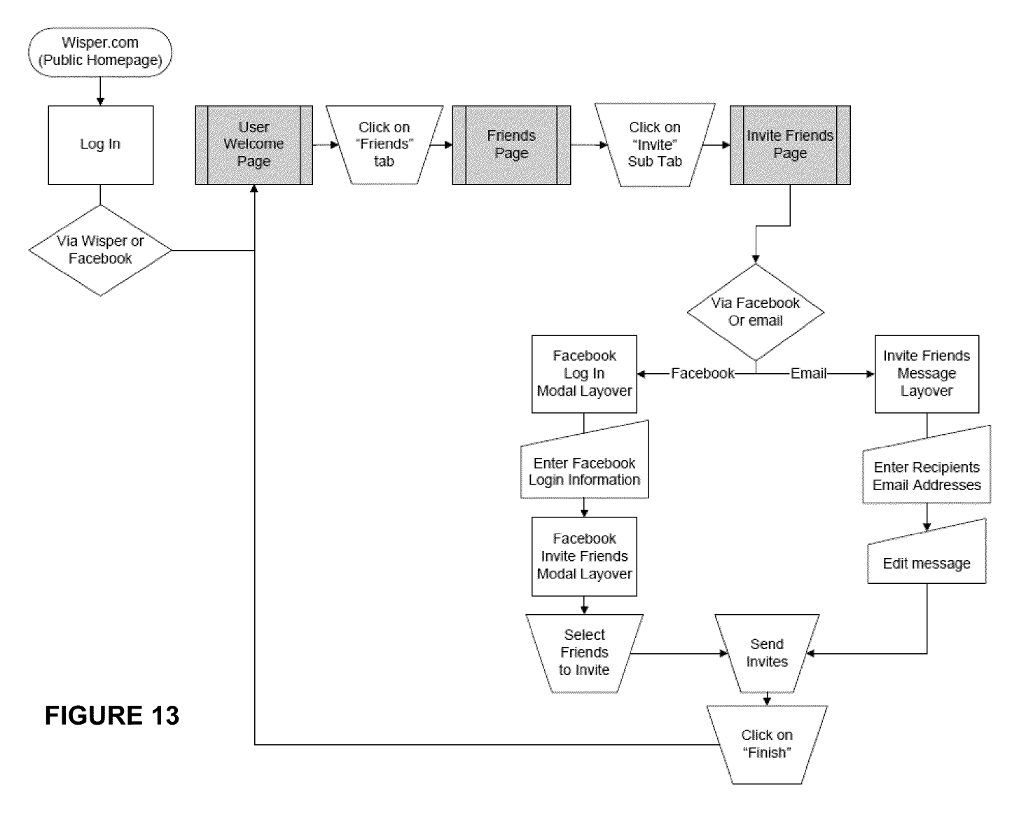

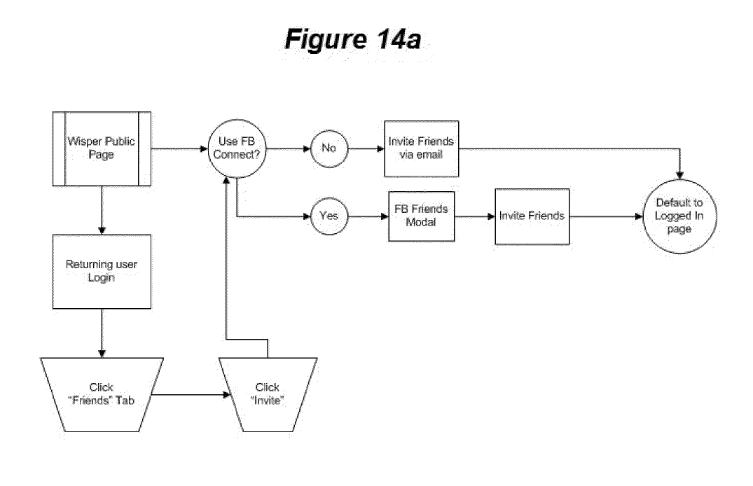

FIG. 12 illustrates a login process of the system for universally managing and implementing commerce rating systems that allows registered users of the system 100 to log into the system. FIGS. 13 and 14A illustrate a flow and process to allow a registered user of the system to invite friends to use the system for universally managing and implementing commerce rating systems.

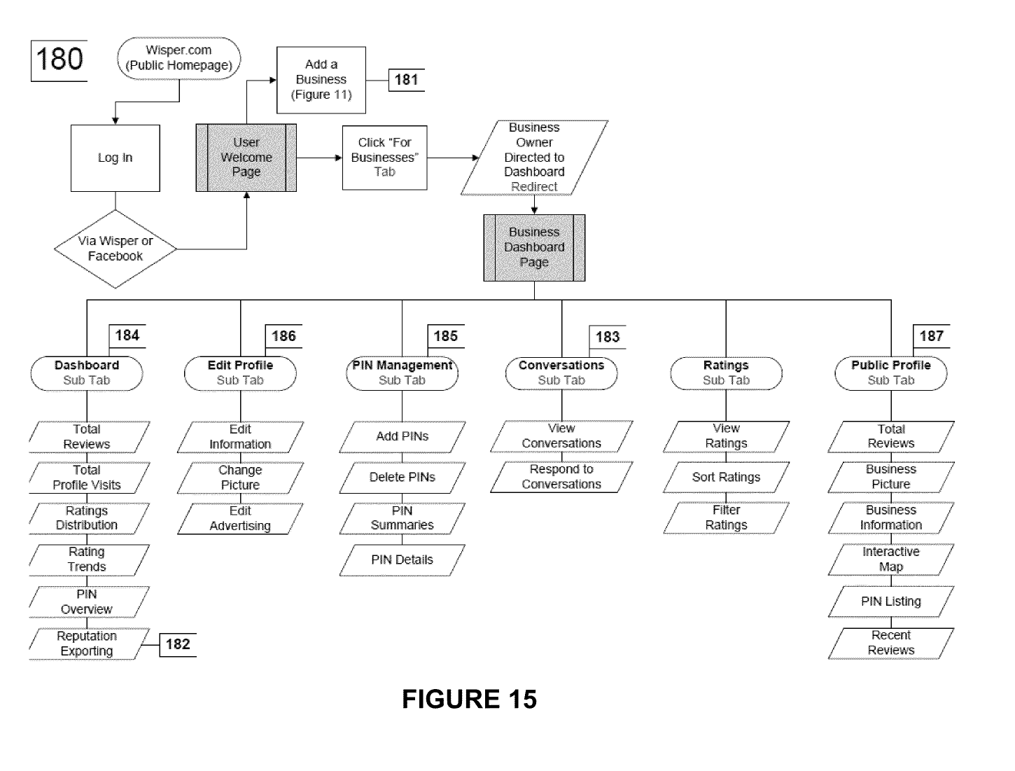

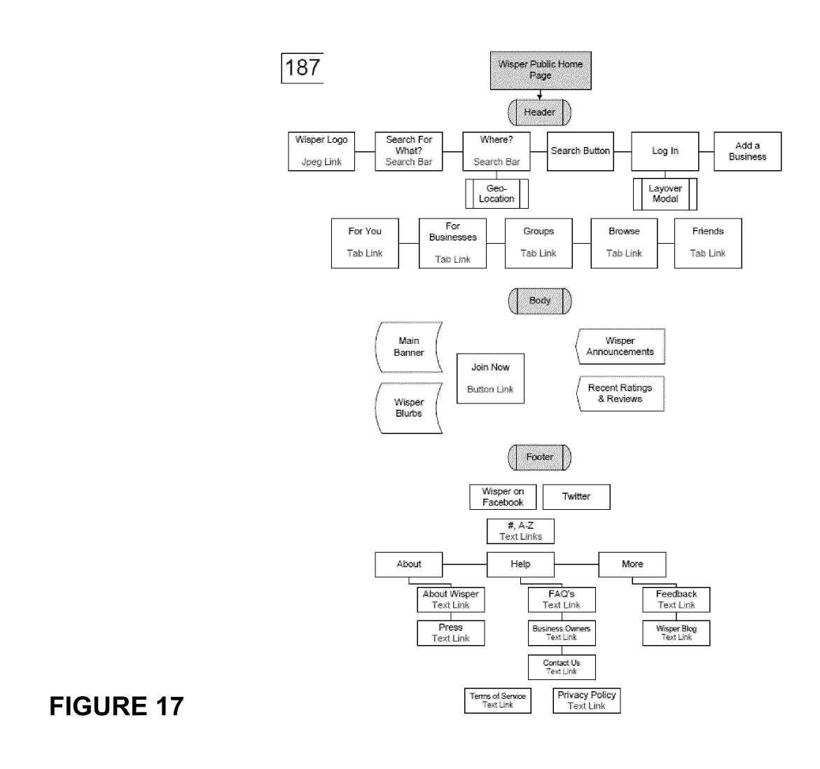

FIG. 15 illustrates a business flow 180 of the system for universally managing and implementing commerce rating systems. The flow includes a process to add a new business flow 181 (which is illustrated in more details in FIG. 11), a network flow 182 that allows the business to share ratings and the like using various mechanisms, a conversation flow 183 that allows the business to interact with customers/bad reviews as described above, a dashboard 184 (illustrated in FIG. 11 and described in more detail below), a pin management process 185 (illustrated in more detail in FIG. 11), a profile portion 186 and a public page portion 187 (that is illustrated in more detail in FIG. 17).

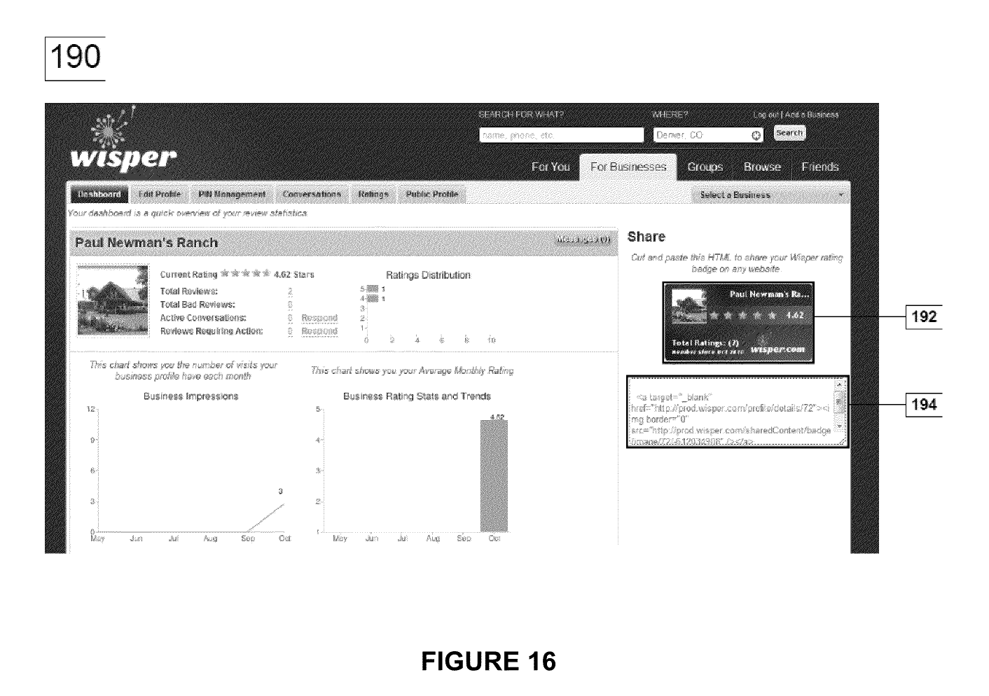

FIG. 16 illustrates an example of a user interface 190 of the universally managing and implementing commerce rating systems that has a portable rating card. The system provides a mechanism to share/review ratings history from the system so that the rating can be incorporated into other systems/Websites (such as Craigslist) that does not have a ratings system. In addition, the share/review ratings history is an example of the universal aspect of the system (since the ratings generated by the system can be universally used). In one implementation, the rating system has a portable rating card/window 192 that can be used by a merchant/business or customer of the system. The portable rating card/window 192 can be for a merchant's Website to provide reviews or any other Website/system. The portable rating card/window 192 is implemented as a piece of HTML code that can be embedded into other systems/Websites by selecting the code snippet 194 underneath the portable rating card/window 192 and pasting it into the third party Website/system. The HTML code takes the user who clicks on the link to the system's page with the member or public profile along with the reviews. The system may also provide APIs that allow third parties to interface with the system described below.

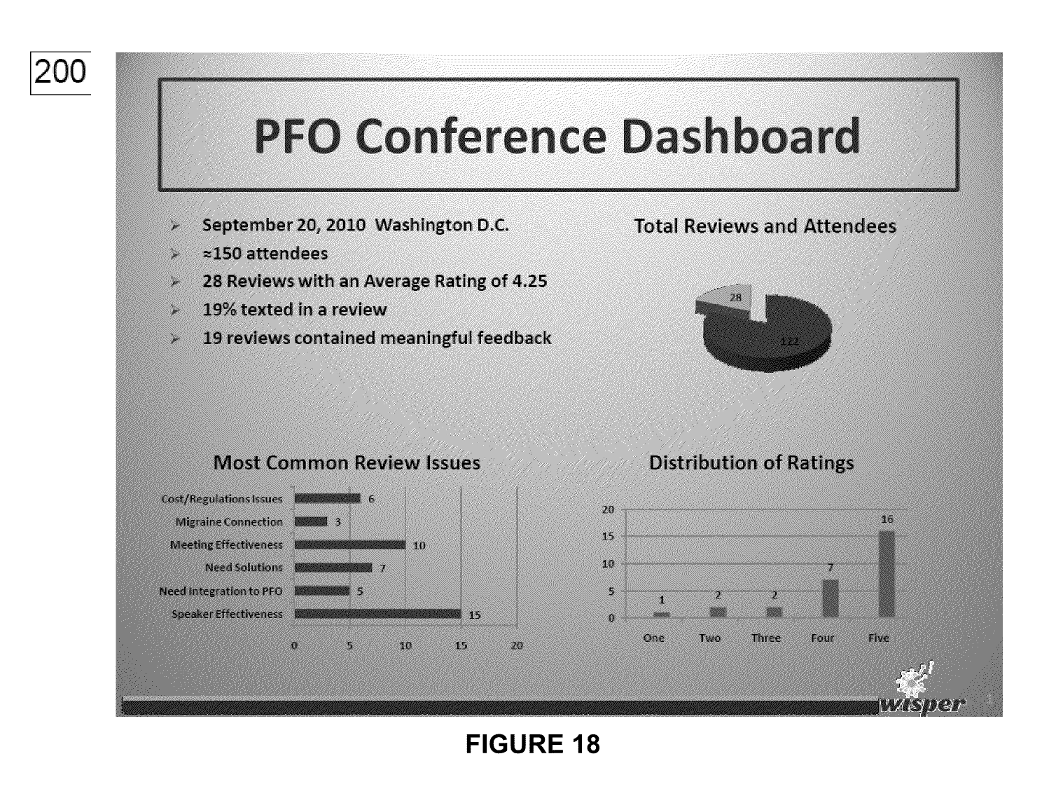

FIG. 18 illustrates an example of a set of reports 200 that can be generated using the system for universally managing and implementing commerce rating systems. As shown, the system may generate a textual report, a pie charts or graphs that display various information collected by the system, such as ratings, the distribution of the ratings, the review issues and the like.

For the reviews/ratings in the system, the system may integrate with different review forms and/or merchants/businesses can be customized review forms. Thus, merchants/businesses can design and implement customized review forms to be communicated to other users (e.g., customers) via test messaging and/or other means of electronic transfer. The system also may have the capability to enable a merchant/business to send targeted messaged, advertisements, or incentives to other users (e.g., customers). In addition, the system may have groups for which a user can sign up (such as a sushi group, a car group) and the users of that group may received ads or information about sushi or cars, respectively based on the interest as expressed by the membership in the group.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A system for communicating and interpreting information between merchants and customers and/or between individuals and organizations who have interest in such information, the system comprising:
a rating unit having a store that contains a personal identification number and telephone number associated with each merchant and each customer who are registered members of the ratings system and a history of communications, organized by unique unregistered phone numbers, with unregistered users;
one or more input/output devices wherein each input/output device is capable of being connected to the rating unit using a link, wherein each input/output device sends a review and the personal identification number associated with the user of the input/output device from the input/output device to the rating unit over the link wherein the link facilitates the rapid input of the review by the input/output device at a point of sale; and
wherein the rating unit further comprises a conversation unit that establishes a conversation for a period of time between a merchant and a customer that submitted a negative review about the merchant to reconcile the negative review and wherein the negative review is publicly available after the period of time.

2. The system of claim 1, wherein the review further comprises one of an advertisement to the customer and a message to the customer.

3. The system of claim 1, wherein the link further comprises one of an SMS message, an email message, a voice message and a message from one of a dedicated rating terminal, a terminal shared between the rating system and a point of sale system and a rating kiosk.

4. The system of claim 1, wherein the rating unit generates a portable rating window for each merchant and each customer and the portable rating window is embeddable in a third party system.

5. The system of claim 4, wherein the portable rating window further comprises a piece of HTML code that is embeddable in a third party system.

6. The system of claim 5, wherein the piece of HTML code is a link to a profile page of a particular user that contains a review summary.

7. The system of claim 4, wherein the portable rating window further comprises an application programming interface (API) that enables data from the system to be viewed from within a third party system.

8. The system of claim 5, wherein the portable rating window is initiated by an application programming interface (API).

9. The system of claim 1, wherein the rating unit further comprises a report generater that generates one or more reports.

10. The system of claim 1, wherein the rating unit further comprises a form of currency.

11. The system of claim 1, wherein the rating unit has an application programming interface (API) module so that a third party system interfaces with the rating unit.

12. The system of claim 1, wherein each input/output device further comprises one of a telephone, a cell phone, a PDA, an interactive TV, a kiosk, a gaming console and a smartphone.

13. The system of claim 1, wherein the rating unit further comprises a rate the rater module that permits a user to rate one of an existing review of another user and another user.

14. The system of claim 11, wherein the third party system imports a set of existing ratings into the rating unit.

15. The system of claim 4, wherein the portable rating window for each merchant further comprises a summary of review information.

16. The system of claim 1, wherein the rating unit further comprises a set of module that are grouped together, wherein the grouped set of modules meet a need of a particular user.

17. A method for communicating and interpreting information between merchants and customers and/or between individuals and organizations who have interest in such information using a rating unit having a store that contains a phone number associated with each merchant, a personal identification number associated with each employee of the merchant and a phone number associated with each customer who are members of the ratings system and one or more input/output devices wherein each input/output device is capable of being connected to the rating unit using a link, the method comprising:
sending, using an input/output device, a review and a personal identification number associated with the user of the input/output device from the input/output device to the rating unit over the link wherein the link facilitates the rapid input of the review by the input/output device at a point of sale;
establishing, using a conversation unit of the rating unit, a conversation for a period of time between a merchant and a customer that submitted a negative review about the merchant to reconcile the negative review; and
making the negative review public after the period of time.

18. The method of claim 17 further comprising generating a portable rating window for each merchant and each customer, wherein the portable rating window is embeddable in a third party system.

19. The method of claim 17 further comprising providing an application programming interface (API) that enables data from the system to be viewed from within a third party systems.

20. The method of claim 18 further comprising initiating the portable rating window using an application programming interface (API).

21. The method of claim 17 further comprising importing a set of existing ratings into the rating unit.

22. A system for communicating and interpreting information between merchants and customers and/or between individuals and organizations who have interest in such information, the system comprising:
a rating unit having a store that contains a personal identification number associated with each merchant and each customer who are members of the ratings system;
one or more input/output devices wherein each input/output device is capable of being connected to the rating unit using a link, wherein each input/output device interacts with the rating unit to define types and categories of information that are of greatest interest to the user of the input/output device;
wherein the rating unit further comprises a review form unit that enables a merchant to design and implement a customized review form, a targeted message unit that enables merchants to send targeted messages to each customer and an application programming interface that enables a merchant to receive rating and review information about the merchant from a plurality of third party systems.

23. The system of claim 22, wherein the rating unit automatically generates electronic messages between users.

24. A system for communicating and interpreting information between merchants and customers and/or between individuals and organizations who have interest in such information, the system comprising:
a rating unit having a store that contains a personal identifier associated with each merchant and each customer who are members of the ratings system, wherein each review and rating of one of a customer and a merchant is correlated to the personal identifier associated with one of the customer and the merchant and that contains each rating and review of one of the customer and the merchant, the unique identifier further comprising a phone number associated with each merchant, a personal identification number associated with each employee of the merchant and a phone number associated with each customer who are members of the ratings system;
wherein the rating unit further comprises an application programming interface to associate a profile of one of the customer and the merchant on a third party system with a profile of one of the customer and the merchant stored by the rating unit, a portable rating window for each merchant and each customer that permits the customers and the merchants to share the rating and reviews with other members of the rating system and is embeddable in third party systems.

25. A system for communicating and interpreting information between merchants and customers and/or between individuals and organizations who have interest in such information, the system comprising:
a rating unit that having a store that contains a personal identifier associated with each merchant and each customer who are members of the ratings system, wherein each review and rating of one of a customer and a merchant is correlated to the personal identifier associated with one of the customer and the merchant and that contains each rating and review of one of the customer and the merchant, the personal identifier further comprising a phone number associated with each merchant, a personal identification number associated with each employee of the merchant and a phone number associated with each customer who are members of the ratings system; and
wherein a particular user uses the personal identifier associated with one of the merchant, an employee of the merchant and a consumer to submit a review using SMS texting that is associated with one of the merchant, an employee of the merchant and a consumer based on the personal identifier.

26. The system of claim 25, wherein the rating unit segregates a review of a particular employee of a particular merchant based on the personal identification number associated with the review that is also associated with the particular employee.

27. The system of claim 25, wherein the rating unit converts the phone number and personal identification number associated with the particular employee into a short code.

28. The system of claim 25, wherein the rating unit segregates a plurality of review submitted to the system based on one of a group and a friend.

29. The system of claim 25, wherein the rating unit further comprises a data mining unit that mines a plurality of keywords in the reviews stored in the system for a particular merchant so that the particular merchant can select one or more keywords to review.

30. The system of claim 25, wherein the review is anonymous but has the personal identifier associated with the review.
